(19) United States
(12) Patent Application Publication
(10) Pub. No.: US 2012/0321418 A1
(43) Pub. Date: Dec. 20, 2012

(54) Device for Coning and/or Deconing a Container and Methods Related Thereto

(76) Inventor: Karl Bohman, Bromma (SE)

(21) Appl. No.: 13/574,820

(22) PCT Filed: Feb. 2, 2011
(86) PCT No.: PCT/SE11/50107

§ 371 Date: Jul. 24, 2012

(30) Foreign Application Priority Data
Feb. 3, 2010 (SE) 1050107-0

(51) Int. Cl. B65G 47/90; B23P 19/00

(52) U.S. Cl. 414/222.07; 29/428; 29/426.1

(57) ABSTRACT

The invention relates to a device for coning and/or deconing a container unit having corner fittings for the attachment of twist-locks. The device has a support structure for the container unit. The support structure has two parallel long sides and two end sides. According to the invention, the device also includes a storage station that is located adjacent and outside one of the end sides. There is a first conveyor means along a first of the long sides and a second conveyor means along a second of the long sides. Each conveyor means is arranged to transport twist-locks to and from the corner fittings from and to the storage station. The invention also relates to corresponding methods for coning and deconing, respectively.

### FIELD OF INVENTION

The present invention in a first aspect relates to a device for coning and/or deconing a container unit having corner fittings for the attachment of twist-locks, which device has a support structure for the container unit, which support structure has two parallel long sides and two end sides. In a second aspect the invention relates to a method for coning a container unit and including the step of inserting a twist-lock at each corner fitting of the container unit and to a method for deconing a container unit including the step of removing a twist-lock from each container box.

With container in the present application, a cargo container of standardized dimensions is intended, primarily but not exclusively ISO-containers of the type 20 ft×8 ft×8′6′ ft or 40 ft×8 ft×8′6′ ft, which have a length of 6.05 m and 12.2 m, respectively, a width of 2.4 m, and a height of 2.6 m. There are also found, though less usual, lengths corresponding to 24, 28, 44, 45, 46, 53 and 58 ft. Accordingly, also these and other container sizes that are standardized, such as High-Cube or SECU-containers, are contained within the concept of cargo containers in the present application.

When containers are unloaded or loaded, it is common to lift several containers arranged together beside each other, e.g., to lift two 20 ft-containers together longitudinally, together they corresponding to approximately one 40 ft-container.

The ISO-containers and normally also other standardized cargo containers are, according to standard, provided with standardized container corners. Each such container corner has a through hole in each one of the three sides of the corner. These corners are intended for different purposes, among others for vertical coupling together of containers stacked on each other and for the attachment of grip devices upon lifting.

With the concept container unit, an individual container that is being unloaded or loaded individually as well as two containers longitudinally arranged together being unloaded or loaded together as one unit is intended.

When a harbour lifting crane unloads or loads, different types of lifts are found. Distinction is made between single lifts, wherein only one container is lifted, twin lifts, wherein two containers are lifted together longitudinally so that they form one container unit, tandem lifts, wherein two containers are lifted together laterally or four containers together both laterally and longitudinally, and vertical tandem lifts, wherein two containers or two pairs of containers arranged together longitudinally are lifted coupled together vertically.

### BACKGROUND OF INVENTION

In unloading or loading of containers from/to a ship, it is important that the entire unloading/loading process is fast. This entails a logistic problem in view of the fact that the number of containers conveyed by the ship could be very great, in the order of up to 10-15 000 TEU (TEU is a standard measure that denotes twenty-feet equivalents), and in view of each container occupying a considerable volume. In that connection, it is important to avoid that bottlenecks arise and enable that the lifting cranes operate continuously without interruptions

When the containers are shipped they are vertically connected to each other by locking units, often of the twist-lock type. The containers are interlocked by these at each corner in that the locking unit at each corner projects through an opening in the corner fitting of the upper container and through an opening in the corner fitting of the lower container. Thereby each twist-lock is in locking engagement with the respective container. When loading the container onto a ship these twist-locks are attached to the bottom of each container, so called coning. Correspondingly the locking units have to be removed after the container is unloaded from the ship, so called deconing. Coning and deconing is time consuming and requires manipulation at each corner of the container. It is also necessary to have the locking units at the right place when coning and to remove the locking units from the corners at deconing. In order to reduce the time for the coning and deconing and in order to at least partly eliminate the need for workers to carry the locking units to or from the container corners there have been suggestions to automatize this handling in various aspects and to various degrees. Examples thereof can be found in WO 2006/024071, EP 1585690 and U.S. Pat. No. 6,688,249.

WO 2006/024071 describes a system for coning and deconing of a container having an assembly at each corner of the cradle receiving the container. Each assembly has a storage for the twist-locks, a manipulation device for the coning/deconing operation and a feeder device for feeding the twist-locks to the manipulation device. Each storage has racks for the twist-locks, which racks by a conveyor can be moved transversally into position for the feeder device. The feeder device has push-rods for moving the twist-locks to or from the manipulating device. In case two containers are received in the cradle four additional assemblies are provided at the mid region of the cradle to take care of the coning/deconing at the corners there.

EP 1585690 describes a device for coning and deconing, which consists of a specific twist-lock container for storage of the twist-locks. When a freight container is to be coned or deconed it is put on the top of the twist lock container. The twist-lock container has openings at its top to allow manipulation of the twist-locks at coning or deconing. Inside the twist-lock container there are vertical and horizontal transporting devices for transporting the twist-locks to and from the openings.

DE 10059260 describes a device that to a large extent is similar to that of EP 1585690 and thus has a twist-lock container arranged in the same manner. At each end of the container there is a transversally movable robot moving the twist-locks to and from the corners.

U.S. Pat. No. 6,688,249 discloses a device having a carrier member on a transport device movable along a rail along the longitudinal direction of the container and which picks up the twist-lock from a supply tray beside the rail and takes it to the corner of the container for coning, and vice versa at deconing.

Through the device according to prior art it has been possible to reduce the operation time for coning/deconing in relation to operation that is substantially manual. Thereby also the safety has been increased. However the systems according to prior art to various degrees still suffer from drawbacks such as complexity in construction and operation, occupation of space at the side of the container, a multitude of storages or the need of a particular twist-lock container.

### SUMMARY OF INVENTION

The object of the present invention is to attain a device for coning/deconing that is highly automatized, minimizes the operation time, maximizes safety and overcomes the drawbacks related to prior art in this field.

The object of the invention is according to the first aspect achieved in that a device for coning/deconing of the kind introductionally specified includes the specific features that the device further includes a storage station adjacent and outside a first of said end sides, a first conveyor means along a first of said long sides and a second conveyor means along a second of said long sides, each said conveyor means being arranged to transport twist-locks to and from the corner fittings from and to the storage station.

By arranging the transport of the twist-locks by conveyor means along the long sides, the time required to have the twist-locks ready for attachment at coning is brought to a minimum, and this relates to deconing as well. Having one single storage stations from and to which the twist-locks are transported makes the device simple and uncomplicated. By this arrangement also the space occupied by the storage station will be limited. In most ports the space along the long sides of the container unit has to be used by other handling equipment such as lorries and trolleys. Since no space is required outside the long sides of the container unit by the invented device, the risk for interference with these other handling equipments in the port is eliminated. This optimizes the logistic of the complete handling chain for the containers and reduces the risk for accidents. The device is simple and uncomplicated in its construction and operation in comparison with earlier suggestions for automatizing the coning and deconing, which leads to a high degree of reliability.

According to a preferred embodiment of the invention each conveyor means includes a plurality of parallel conveyors arranged side by side.

Along each container unit there are at least two corner fittings to be coned or deconed. By having a plurality of conveyors the transportation to and from these boxes can be made simultaneously which further contributes to minimize the operation time. The accuracy will also be increased.

According to a further preferred embodiment the number of conveyors is three or four.

For a container unit consisting of only one 40-feet container it is sufficient with two conveyors in each conveyor means. Frequently, however the container unit consists of two 20-feet containers arranged together end to end. In that case there are two corner fittings also at the middle of the long side. This embodiment makes the device particularly adapted to handle also such a pair of containers, whereby one conveyor serves the most close corner fitting, another serves the most remote corner fitting and one or two serve the corner fittings at the middle. Since the boxes at the middle are located close to each other they can advantageously be served by one single conveyor. Thus the alternative to have three conveyors is preferred.

According to a further preferred embodiment, the conveyors in one and the same conveyor means are of different length.

This is an advantageous adaption to the fact that the distances from the storage station to the corner fittings are different and [symbol] .

According to a further preferred embodiment, there is driving means for the conveyors, which driving means is arranged to drive the conveyors of one conveyor means at different speeds.

Since the transporting distances are different it is sufficient that only the conveyor serving the remote corner fitting operates at a speed that is as high as practically applicable. The conveyor serving the middle corner fittings can be operated at much lower speed, and the conveyor serving the most close corner fitting still slower. Thereby the transporting time to each corner fitting will be substantially equal. The conveyors that not move at the highest speed thereby can be made with lower demands on their construction and driving.

According to a further preferred embodiment the driving means includes one electric motor for each conveyor means.

This leads to a particularly simple arrangement for the driving, and each motor can be individually dimensioned to what is required to drive its conveyor. Preferably there is one set of motors for each conveyor means. Alternatively the driving means can be integrated for the two conveyor means such that each motor drive the two corresponding conveyors in both the conveyor means

According to a further preferred embodiment, the driving means includes one single motor for all conveyors in one conveyor means, whereby each conveyor is connected to the motor via an individual gear mechanism.

The arrangement of the driving means is preferably such that there is one set of motors or one single motor for each conveyor means. Optionally the driving means can be integrated for the two conveyor means such that the corresponding conveyors of the two conveyor means are driven by a common motor. Also in this embodiment the single motor is provided for each conveyor means or the single motor can be common for both the conveyor means

This is an alternative to the embodiment mentioned next above and has the advantage that only one motor is required. By having gear mechanisms of different ratios, the speed can be adapted to the need of each conveyor.

According to a further preferred embodiment, each conveyor includes at least one gripping device arranged for gripping a twist-lock.

The gripping device is for the purpose of holding the twist-lock during the transport by the conveyor and for manipulating the twist-lock at coning/deconing.

The gripping device provides a safe transportation and eliminates the need for any additional equipment at the coning/deconing. Normally only the conveyor serving the middle boxes has two gripping device, whereas the other have only one single gripping device.

According to a further preferred embodiment the gripping device is an integral mechanical part of the conveyor to move simultaneously therewith. This leads to a robust, reliable and precise construction and operation.

According to a further preferred embodiment, there are positioning means arranged to stop each conveyor at at least one predetermined position, corresponding to the position when the gripping device is located right under a corner fitting.

This further increases the automatization and provides in a simple way a precision for aligning the gripping device with the corner fitting. The need for any manual operation for the proper positioning of the gripping device is eliminated.

According to a further preferred embodiment, the position means includes a sensor and/or a mechanical stop.

By means of a sensor the positioning will be simple and accurate. The mechanical stop can either be an alternative to the use of a sensor or be a complement thereto to increase the safety.

According to a further preferred embodiment, the conveyer means are arranged to transport twist-locks to and/from the corner fittings of at least two containers connected to each other end against end.

As mentioned the container unit often consists of two containers connected together in this way and by this embodiment the device is particularly suitable for handling such pairs of containers.

According to a further preferred embodiment, the device further includes a container handling device by which the container unit is vertically movable.

At the moment of coning or deconing it is normally necessary to move the container unit and the twist-lock vertically a small distance in relation to each other. By this embodiment the relative vertical movement is achieved in a simple way. The vertical movement of the container unit has also the advantage that the container handling device can be constructed to house two container units arranged one above the other.

According to a further preferred embodiment, the container handling device is arranged to be able to receive at least one pair of container units with one unit in the pair container of units being situated above the other one, which container handling device comprises a support structure, a loading platform connected with the support structure and a transfer device connected with the support structure, which transfer device is arranged to move a container unit laterally, and comprises a laterally moveable grip frame arranged to be able to surround at least three of the vertical side walls of a container unit and which grip frame (8) has inside dimensions that are greater than the cross-sectional dimensions of a container unit in a horizontal plane so that a vertical movement of a container unit through the grip frame (8) is possible.

The advantage of this embodiment is that two containers can be loaded or unloaded simultaneously which further reduces the operation time at loading or unloading. The advantages of the invented device for coning/deconing thereby become still more valuable.

The object of the invention is according to the second aspect of the invention achieved in that the method for coning and the method for deconing of the kind introductionally specified include the specific measures of placing the container unit on a support structure with two parallel long sides and two end sides, providing a storage station adjacent and outside one of the end sides, providing conveyor means along each long side, and transporting a twist-lock to/from each corner fitting by the conveyor means from/to the storage station.

According to preferred embodiments of the invented methods they are performed by a device according to the present invention, in particular to any of the preferred embodiments thereof.

The invented methods and the preferred embodiments thereof have the same advantages as those of the invented device and the preferred embodiments thereof and which have been described above.

The above described preferred embodiments of the invention are specified in the dependent claims. It is to be understood that further preferred embodiments of course can be constituted by any possible combination of the preferred embodiments above and by any possible combination of these and features mentioned in the description of examples below.

The invention will be further explained through the following detailed description of examples thereof and with reference to the accompanying drawings

### SHORT DESCRIPTION OF THE DRAWINGS

FIG. 1. Is a perspective view of a device according to the invention.

FIG. 2 is a perspective view of a detail of the device of FIG. 1.

FIG. 3 is a perspective view of a detail of FIG. 2.

FIG. 4 is a cross section through the detail of FIG. 3,

FIG. 5 is a perspective view of a conveyor according to the invention.

FIG. 6 is a perspective view of a twist-lock and a corner fitting ready for coning.

FIG. 7 to FIG. 10 in similar views as in FIG. 6 illustrate consecutive further steps of the coning.

FIG. 11 is a perspective view of a twist-lock and a corner fitting ready for deconing.

FIG. 12 to FIG. 15 in similar views as in FIG. 11 illustrate consecutive further steps of the deconing.

FIG. 16 is a perspective view of a device according to an alternative example of the invention.

FIG. 17 is a perspective view of the device of FIG. 16 in which the device is in another operating stage.

### DESCRIPTION OF EXAMPLES

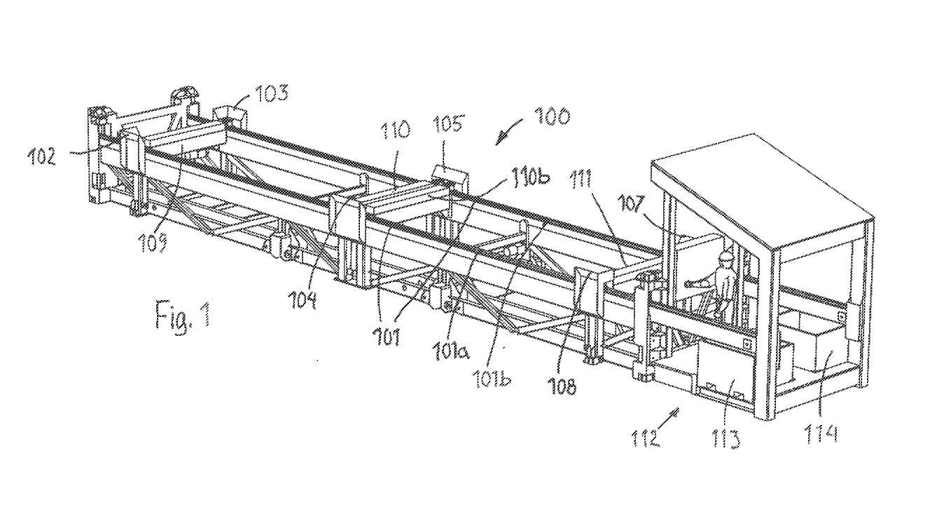

FIG. 1 in a perspective view illustrates one example of a device for coning and deconing according to the invention. The device has a support structure 100 adapted to receive one 40-feet container or two 20-feet containers connected to each other end by end to form a common container unit. The operation of the device will in the following be explained for the latter case, i.e. two 20-feet containers. The explanation will mainly relate to the deconing operation, through which it is easily understood also how the coning operation is made.

Deconing is to be made when unloading the pair of containers from a ship. The pair of containers is unloaded by a port crane and is by the crane put for temporary storage on the support structure 100 such that it will rest on the support beams 109, 110a, 110b and 11 which all extend transversally to the longitudinal direction of the support structure 100. At this stage there are twist-locks attached to the underside of the container unit. There are one twist-lock in each corner fitting of the container unit. Thus it has eight twist-locks attached thereto, of which four are attached in the longitudinal middle area where the two containers in the container unit meet each other.

The support structure 100 also has vertical corner guides 102, 103, 107,108 for the corners of the container unit and vertical middle guides 104,105 at the middle of the container unit, where the two containers meet each other. By these guides, which all have their interior sides inclined, the container unit will be guided into a correct position on the support structure 100. The support beams 109, 11 0a, 110b, 111 are all vertically movable, for a purpose later to be explained. In the longitudinal direction of the support structure 100 there are two parallel conveyor lines 101a, 101b. Each of these are located beneath the container unit close to a respective longitudinal side thereof such that the conveyer means 101a, 101b will be aligned with the position of the locking twist-locks that are attached to the container unit.

When the container unit is in the proper position the twist-locks are deconed therefrom and then transported by the conveyer means 101a, 101b to a storage station 112 at the end of the device. From there the twist-locks are removed from the conveyer means 101a, 101b and collected in storage boxes 113, 114. This can either be made manually as illustrated in the figure or automatized, e.g. by a robot.

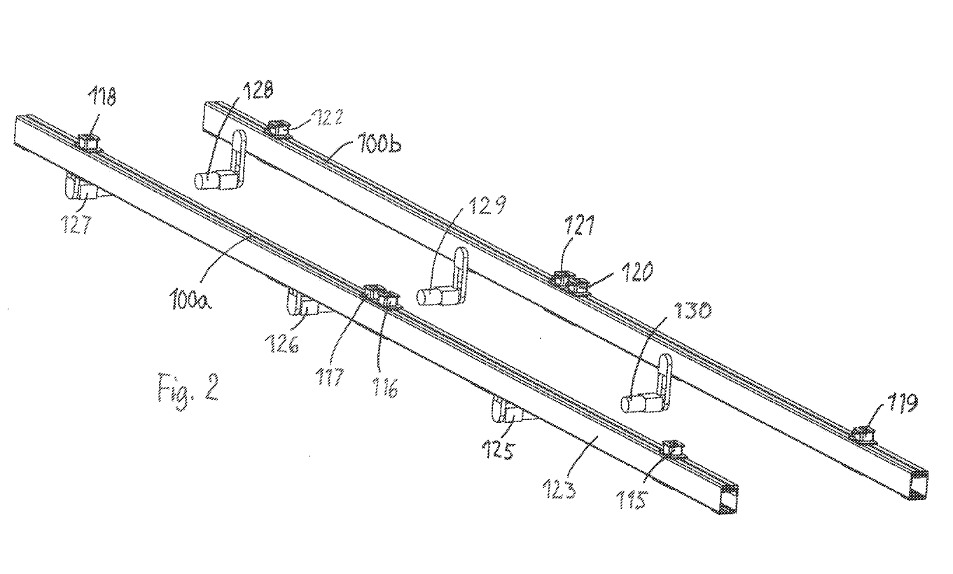

FIG. 2 illustrates the conveyer means 101a, 101b more in detail, and in this figure other part of the device is left out. Each conveyer line 101a, 101b of the conveyer means has a longitudinal hollow rectangular beam 123, 124, and each of these supports three conveyers (not visible in the figure). The arrangement and function of the conveyers will be explained only for the conveyer means 100b, since this applies also to the other one. There are four gripping units 119, 120, 121, 122 arranged to be moved by the conveyers in the conveyer means 100b. Each gripping unit 119, 120,121, 122 has the dual purpose of gripping a twist-lock while simultaneously loosing it from the respective corner fitting of the container and then transport the twist-lock to the storage station 112.

A first of the gripping units 119 is connected to a first conveyer for transporting the locking unit from the nearest container corner fitting to the storage station 112. A second 120 and a third 121 gripping unit are connected to a second conveyor for transporting the locking units from the corner fittings of the two containers that meet each other at the middle of the device to the storage station 112. A fourth gripping unit 122 is connected to a third conveyor for transporting the twist-lock from the most distant corner of the container unit. The lengths of the conveyors are correspondingly different. Each conveyor is driven by a respective electric motor 128, 129, 130. The conveyors are driven at different speeds since the travelling distance to the storage station 112 from the respective corner fittings are different. Thereby can be attained that the time required to transport the gripping units 119, 120, 121, 122 to the storage station 112 are substantially equal.

As an alternative, the three electric motors 128, 129, 130 can be replaced by one single electric motor driving all three conveyors. In that case the transmission from the motor to the conveyors includes a respective gearing mechanism for each conveyor to obtain the different speeds.

Although it is advantageous to have different speeds for the conveyor belts, it is to be understood that driving the conveyors with the same speed is within the scope of the invention.

The arrangement of the conveyors in conveyor means 100a and the drive system with the motors 125, 126, 127 corresponds to what have been described above for conveyor line 100b. As a further alternative, the pair of motors 125, 130 for the two shortest conveyors can be replaced by one common motor for these, and a corresponding replacement of the other two pair of motors. In a still further alternative, one single motor can be used to drive all six conveyors, whereby the gear mechanisms can be common for each pair of conveyors.

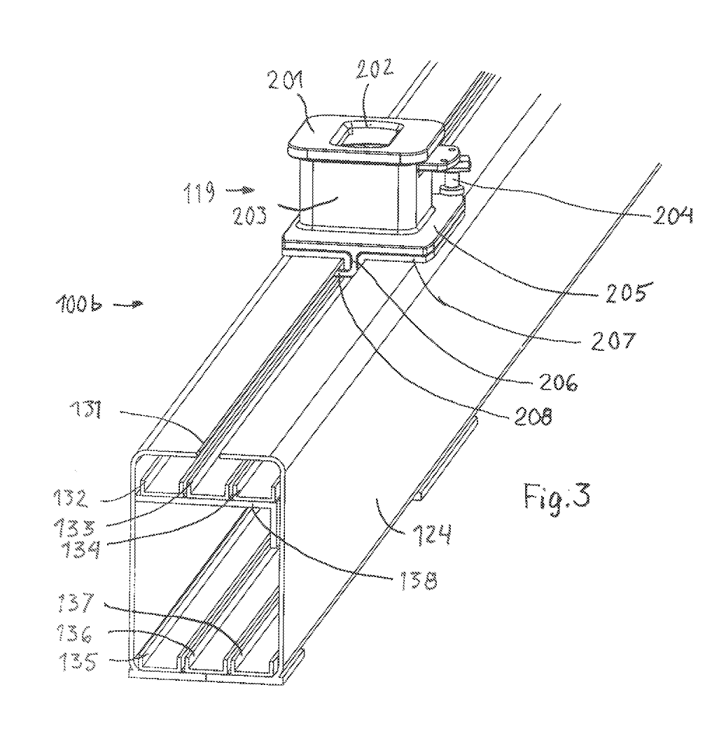

FIG. 3 in an enlarged perspective view illustrates the conveyor means more in detail with reference to conveyor means 101b. During transportation the gripping unit 119 slides on the top of the hollow beam 124 driven by its conveyor. The gripping unit 119 has a housing 203 in which the lower part of the twist-lock is housed during transportation. At the top there is a cover plate 201 with a rectangular opening 202 through which the lower part of the twist-lock is inserted at deconing. Inside the hosing 203 there is a mechanism through which the twist-lock either can be locked or released for coning and deconing respectively. By a handle 204 this mechanism can be put in the required mode for coning or deconing. The bottom plate 205, by which the gripping unit slides on the top of the beam 124 has a central projection 206 directed downwards, which extends through a longitudinal slot 131 on the top of the beam 124. Through this projection 206 the gripping unit 119 is connected to its conveyor inside the beam 124. On the underside of the bottom plate 205 there is an anti friction layer 207 of plastic, which layer also extends on the sides of the projection 206.

At the end of the beam 124, guiding rails 132-137 for the conveyors can be seen. The upper three guiding rails 132, 133, 134 are located side by side supported by a horizontal partition 138 in the hollow beam 124. Each of them guides its respective conveyor at the active part thereof. The guiding rails 135, 136, 137 guide the respective return part of the conveyors. Note that the conveyors as such are left out in the figure.

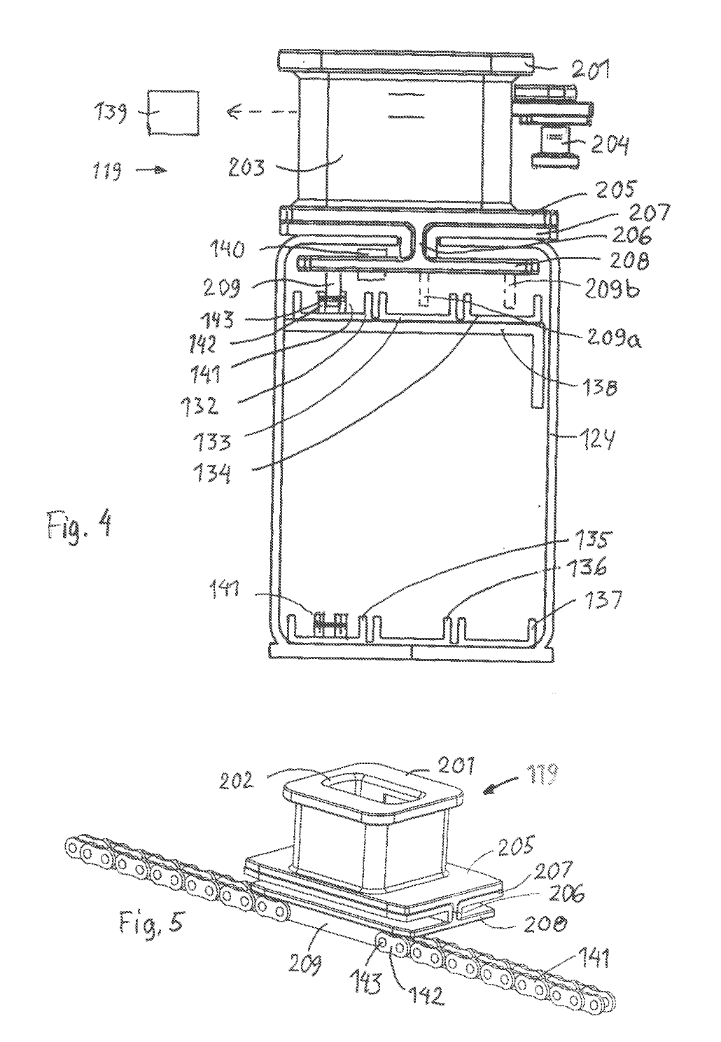

FIG. 4 is a cross section of the beam 124 taken adjacent the gripping unit 119. At the lower end of the projection 206 there is a horizontal plate 208 with a connection member 209 extending downwards from the plate 208 at the left side thereof as seen in the figure. The connection member 209 forms a part of the conveyor 141 which in this example is a conveyor chain. A pin 143 extends through the connection member 209 and a link 142 of the conveyor chain 141 at each end of the connection member.

The gripping units 120, 121 (see FIG. 2) for deconing at the middle of the container unit are of the same construction as the gripping unit 119 except for the location of the connection member. For these gripping units the respective connection member 209a extends from the middle of the plate 208 and are drawn by broken lines in the figure. The connection member is connected to a conveyor chain (not shown) located in the middle guiding rail 133 in the same way as described above. Correspondingly the gripping unit 122 for deconing the remote container corner has a connection member 209b at the right side of its plate 208 connected to a conveyor chain in the right guiding rail 134.

When the gripping unit 119 travels to the position for deconing the related corner fitting, the movement of the conveyor 141 has to stop at the proper position. This is achieved by a sensor 139, e. g. a photocell sensing the position of the gripping unit 119. The sensor 139 is connected to the drive system of the conveyor 141 and stops the driving a short distance before its coning position representing the retardation distance. In addition there is a mechanical stop 140, stopping the plate 208 to move further. The mechanical stop 140 is mainly for safety reason and could be omitted. Alternatively the mechanical stop could replace the sensor 139.

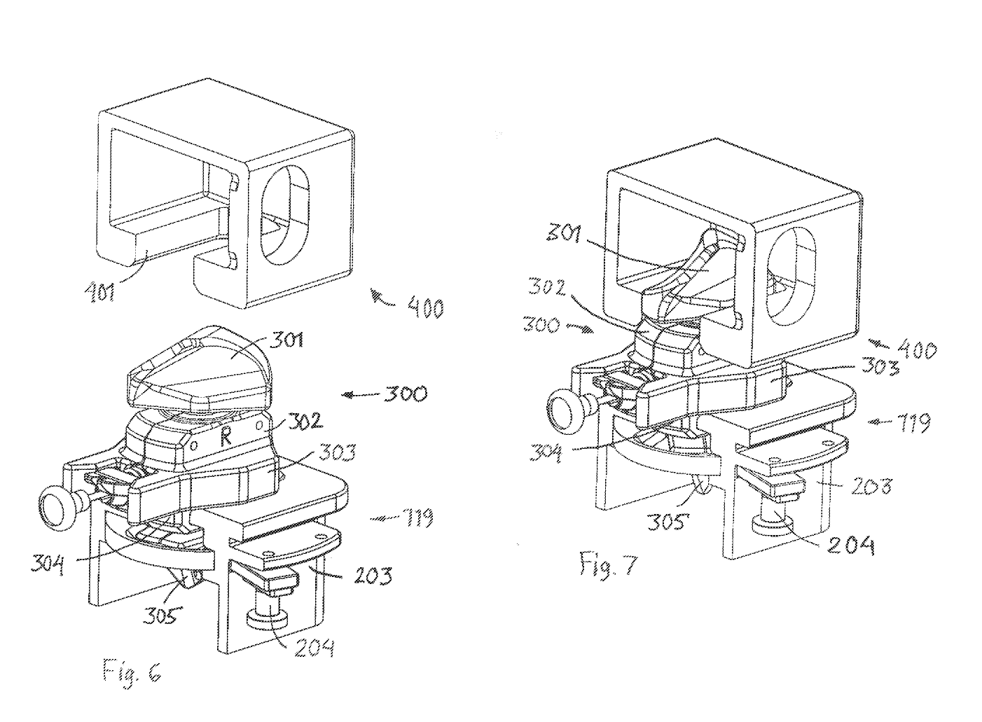

In the perspective view of FIG. 5 the connection of the gripping unit 119 to the conveyor 141 is illustrated more in detail.

The above description of the device relates to deconing operation. The coning operation is carried out substantially in the same way but reversed. At coning the gripping devices thus transport twist-locks from the storage station 112 to the corner fittings of the container unit. The twist-locks then are loosened from the gripping devices and attached into the corner fittings.

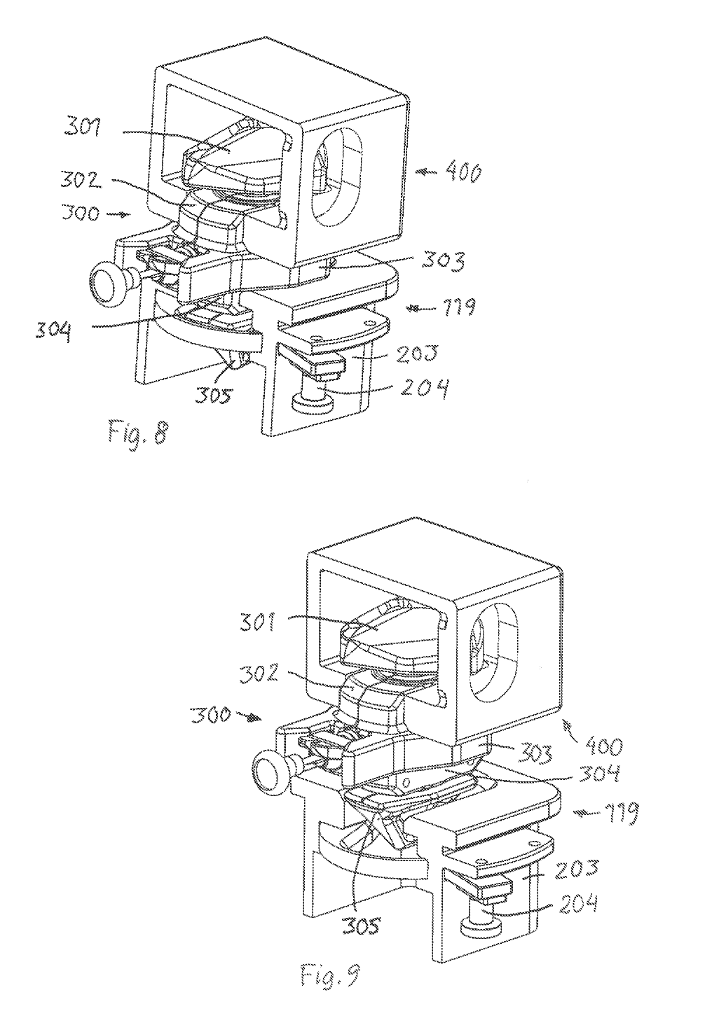

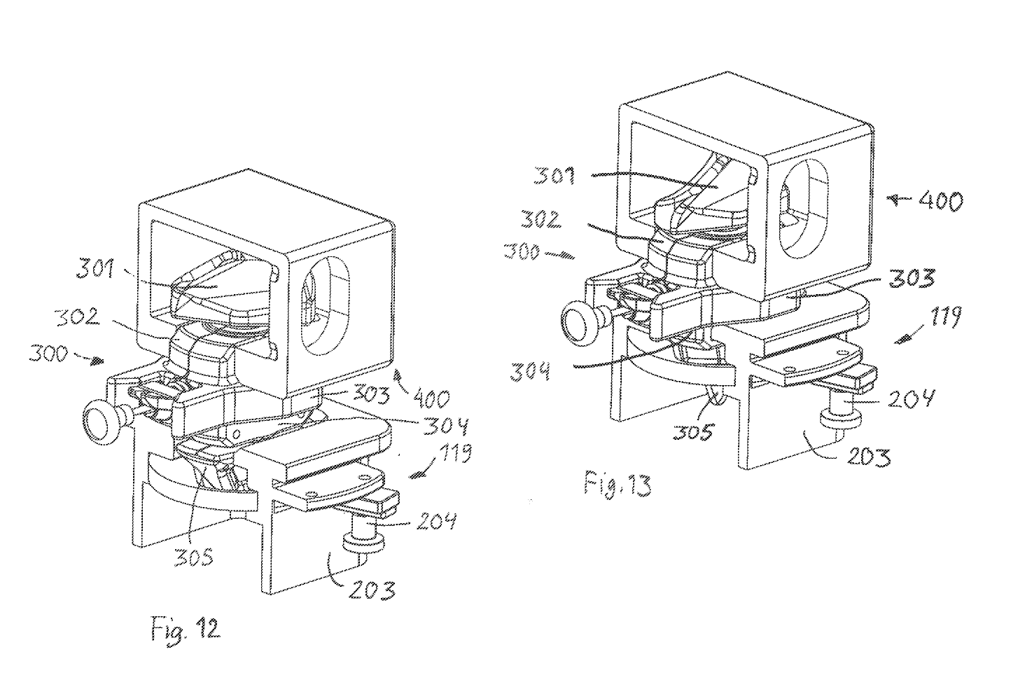

How the coning and deconing as such are carried out is explained in relation to FIGS. 6 to 15, where FIGS. 6 to 10 refers to coning and FIG. 11 to 15 to deconing.

FIGS. 6 to 10 illustrate how a twist-lock 300 is moved from the gripping unit 119 to a corner fitting 400 of a container. The twist-lock 300 is of a common type used for connecting containers to each another. The twist-lock has a body 303, 304, 305 and a locking member 301, 305. The locking member consists of an upper locking part 301 and a lower locking part 305 which are connected to each other. The locking member 301, 305 is rotatable arranged relative to the body 302, 303, 304 around a vertical axis. The locking member 301, 305 is angularly urged in the clockwise direction by a spring mechanism located within the body.

In these figures only the corner fitting 400 of the container is shown, but it is to be understood that such a corner fitting form a part of the container at each corner thereof. The corner fitting 400 as well as the gripping unit 119 are cut up for sake of clarity. A part of both these details at the end facing forward to the left is thus cut away.

FIG. 6 illustrates the stage when the gripping unit 119 has reached its proper position in alignment with the corner fitting 400. The upper locking part 301 and an upper portion 302 of the body thereby are in a position where they can enter through the opening 401 in the bottom of the corner fitting 400 by vertical relative movement, e.g. by lowering the container through the support beams 109, 110, 110a, 111 (see FIG. 1). Initially the upper locking part 301 is in an angular position such that it does not fit through the opening 401. The upper side of the upper locking part 301 has a specific geometry such that in contact with the lower edge of the opening 401 it will rotate counter-clockwise by the cam action established between its upper side and the lower edge of the opening. The rotation takes place against the action of the spring mechanism within the body.

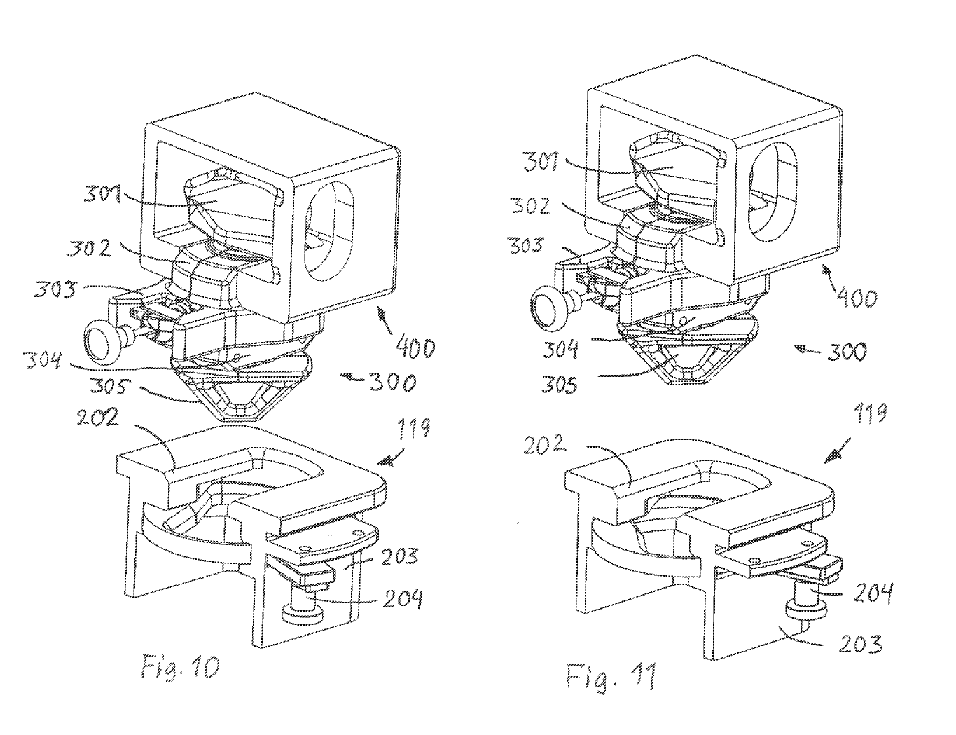

FIG. 7 illustrates a first stage of this vertical movement, when the upper locking part 301 passes through the opening 401, and being angularly displaced with respect to the position in FIG. 6.

In FIG. 8 the movement has continued further. The upper locking part 301 is now in a position within the corner fitting 400 and the upper body portion 302 is located in the opening 401. In this position the spring mechanism has forced the upper locking part 301 clockwise to the same angular position as in FIG. 6. Thereby the underside of the upper locking part rests against the bottom of the corner fitting and is prevented from moving downwards out of the corner fitting. The underside of the corner fitting 400 abuts a central body portion 303, which is laterally wider than the upper body portion 302.

Further upward movement of the container unit, as shown in FIG. 9, results in that the corner fitting 400 lifts the twist-lock 300. The lower 305 locking part, which is rotationally coupled to the upper locking part 302 thereby is in an angular position such that it can pass through the opening 202 in the cover plate 201 of the gripping unit 119.

When the lower locking part 305 is released from the gripping unit 119 as illustrated in FIG. 10, the locking parts 301, 305 are further angularly displaced in the clockwise direction by the spring mechanism, whereby the locking of the twist-lock in the container is completed and safe. When the lower locking part 305 was located within the gripping unit 119, the geometrical relationship between the lower locking part 305 and the interior of the housing established a limit in the clockwise direction for the angular position of the locking member 201, 205. The geometry of the interior of the housing 203 of the gripping unit 119 is adjustable by the handle 204 for coning or deconing mode, and in FIGS. 6 to 10 this handle thus is in the coning mode position.

Deconing is illustrated in FIGS. 11 to 15. Since the operation is very miler to the coning described in connection with FIGS. 6 to 10 a very brief explanation of the deconing will be made.

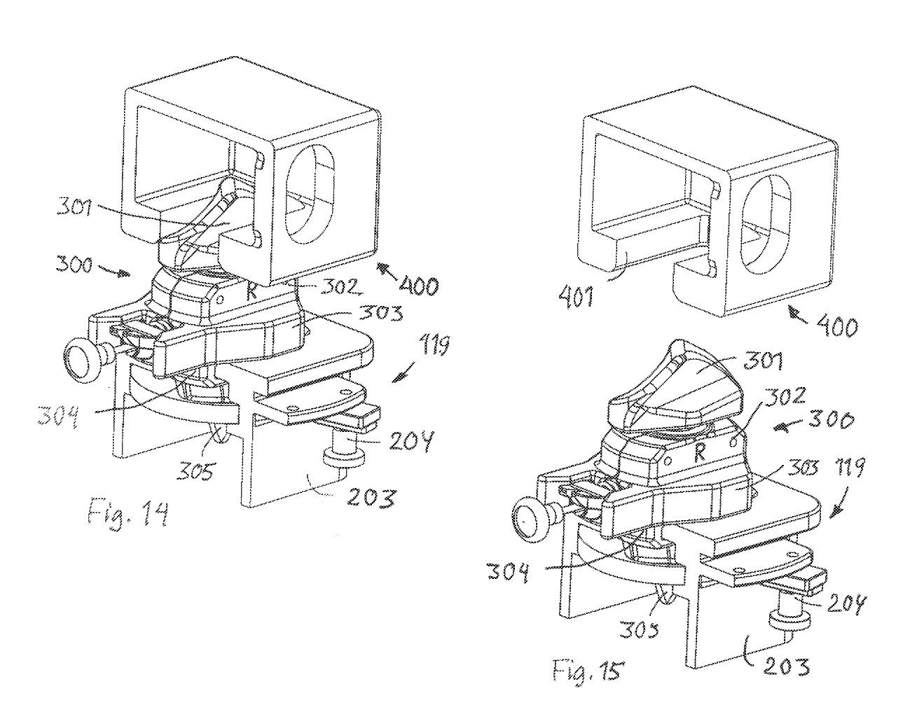

In FIG. 11 the gripping unit 119 has reached the position where it is aligned with a corner fitting 400 of the container. The handle 204 is in a position for deconing mode. The upper locking part 301 safely locks the twist-lock to the corner fitting 400. When the container is lowed as in FIG. 12 the interior of the housing 203 cooperates with the lower locking part 205 to force it to rotate counter-clockwise, whereby also the upper locking part 201 rotates correspondingly. In FIG. 13 the upper locking part 201 has rotated sufficient to be able to pass through the opening 401 in the bottom of the corner fitting 400 as can be seen in FIG. 14. In FIG. 15 the twist-lock 300 is deconed and is ready for transport from the container corner to the storage station 112.

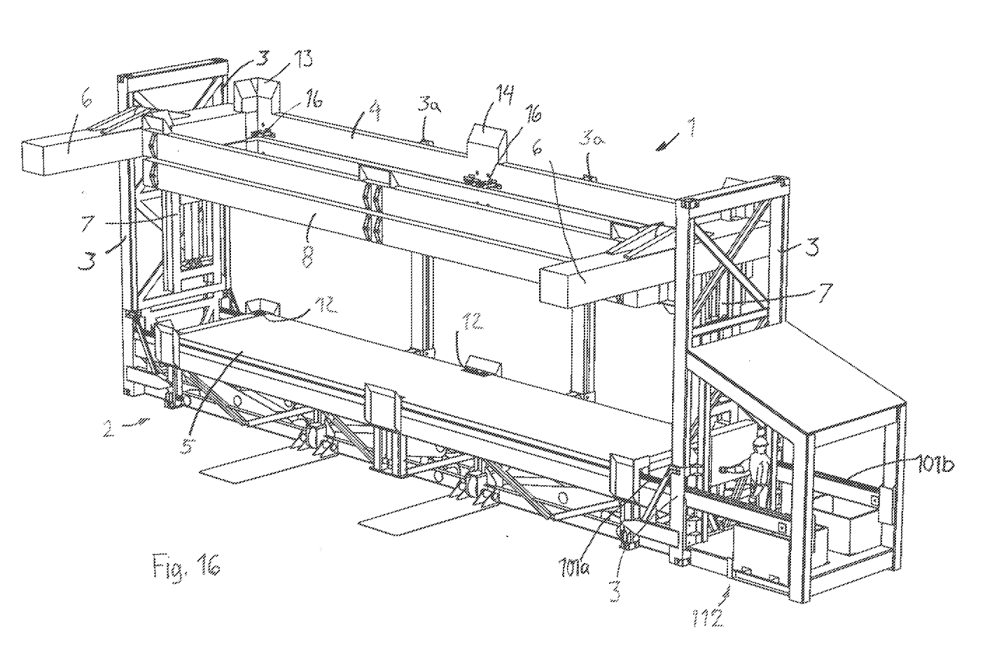

In FIG. 16 an example of the invention is illustrated in connection with a particular container handling device capable of storing two container units above each other. This figure is a perspective view of the same and in the empty state, i.e., before it has received any container. It is box-shaped with a support structure 1 consisting of a bottom part 2, four cornered supporting posts 3 and a rectangular support frame 4 situated at the top. In the example shown, the support structure has also two central supporting posts 3a situated in the vicinity of the middle of one long side. On the bottom part 2, there is a loading platform 5 that is vertically adjustable by a driving device, not shown in more detail, under the same in the bottom part 2. The driving device may be of conventional kind, such as an electric motor or pneumatically or hydraulically operated.

The container handling device is furthermore provided with a transfer device that consists of a lifting mechanism 7 in each end wall with a rectangular grip frame 8 connected to the lifting mechanism 7. The lifting mechanism 7 is horizontally displaceable on beams 6.

The example shown in the figure is intended for a container unit corresponding to two 20 ft containers arranged together longitudinally or a sole 40 ft container. In the following, the function of the container handling device will be described in connection with two 20 ft containers.

The support frame 4 as well as the grip frame 8 has inner dimensions that allow passage of two 20 ft containers between each one of them. Each frame has accordingly an inner length of slightly more than 12.2 m and an inner width of slightly more than 2.5 m, suitably some centimetres or at the top a pair of tens of centimetres longer in each direction. It should be a sufficiently large play between the sides of the container unit and the respective frame so that passage of the container unit becomes problem-free. On the other hand, the play should be as small as possible, particularly in the cross direction for the facilitation of clamping of a container unit to either of the frames 4, 8. A well-judged balance between these needs means that each inside dimension should be in the range of 1-30 cm longer than the corresponding dimension of the container unit, preferably in the range of 5-15 cm.

In the example, the container handling device has a front side and a back side on the respective long side, the central supporting post 3a being situated at its back side. The front side is entirely open and is intended for a container unit to be transferable out or in through the same. The distance between the corner post 3 on the front side is accordingly somewhat greater than the length of the container unit and so that the end wall parts of the transfer device simultaneously have room between the corner pillars in the transfer motion. The distance is accordingly in the order of 12.5-13 m, and the height, i.e., the distance between the loading platform 5 in its lowermost position and the support frame 4, is at least 2.6 m, suitably 2.8-3.5 m.

The loading platform 5 has recesses 12 in each corner and at the middle to give room for the corners of the container unit, in order to facilitate coning and deconing.

The support frame 4 is provided with obliquely outwardly upwardly directed guide plates 13 at an angle in each corner and a plane obliquely outwardly directed guide plate 14 in the middle of each long side. In this way, centring is facilitated when a container unit is lifted down from a crane.

On each girder on the long side of the support frame 4, there are four studs 16 that are displaceable in holes through the respective girder. The studs 16 can be pushed inward to the shown position so that they protrude on the inside of the respective girder. The studs are placed in the longitudinal direction so that they, in that direction, are located right opposite a hole each in one of the container corners. The two middle studs are intended to be projectable into the corners at the ends of the containers facing each other when the container unit consists of three 20 ft containers. The studs 16 are provided with actuators, e.g., electric or hydraulic, and are ,remote-controlled via electric and hydraulic lines, respectively. This may be effected manually, or automatically triggered by a handling step in the container handling device. The studs are actuated simultaneously. The actuation system may be formed so that the middle ones of the studs 16 are not actuated when the container handling device is used for a 40 ft container.

On each girder on the long side of the grip frame, there are corresponding studs (not visible) arranged in holes in the girder. Their function and actuation are of the same kind as described above for the studs 16 of the support frame.

The container handling device of FIG. 16 is capable of temporary store and handle two container units at loading and unloading, whereby one container unit is supported by the loading platform 5 and the other by the support frame 4. By means of the transfer device a container unit can be moved out from the platform 5 to a lorry on the side of the device, and simultaneously house a second container at the top attached at its bottom to the support frame 4.

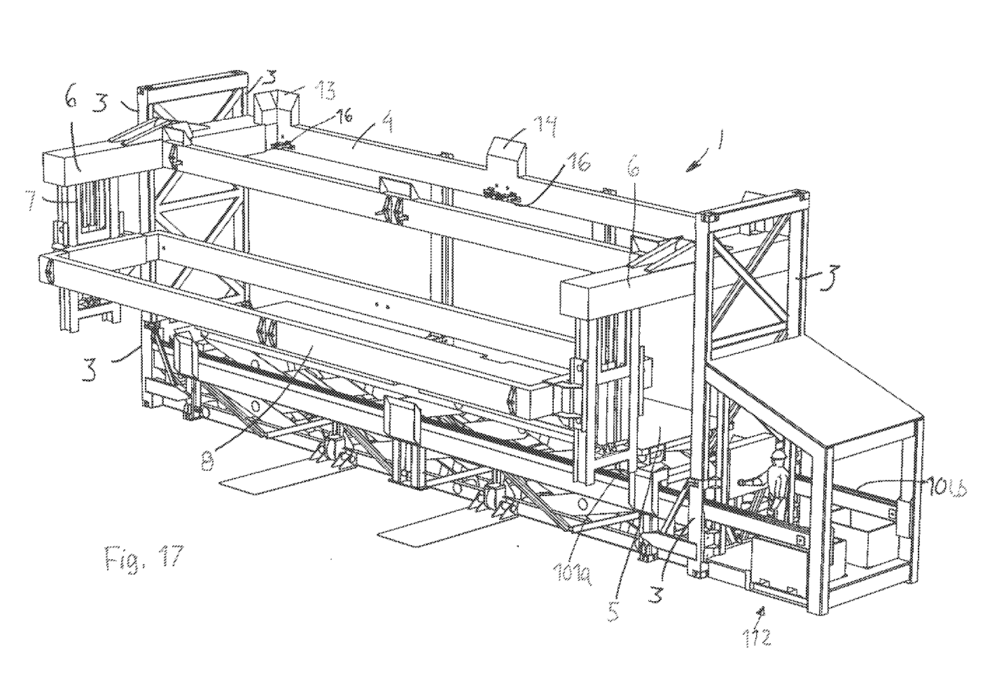

FIG. 17 illustrates the device during such operation. In this figure the lifting mechanism 7 has been moved out wards on the beams 6 together with the grip frame 8, which holds the container unit. When the grip frame has been moved far enough such that the container unit is completely outside the platform 5, the lifting mechanism 7 lowers the grip frame 8 for unloading the container unit to the lorry. Then the upper container unit can be lowered to the platform 5 for deconing and transfer to a lorry.

At loading the operation is similar but reversed.

At Coning/deconing, the twist-locks are transported by the conveyor means as in the first described example.

1. A device for coning and/or deconing a container unit having corner fittings for the attachment of twist-locks, which device has a support structure for the container unit, which support structure has two parallel long sides and two end sides, wherein the device further includes a storage station adjacent and outside a first of said end sides, a first conveyor means along a first of said long sides and a second conveyor means along a second of said long sides, each said conveyor means being arranged to transport twist-locks to and from the corner fittings from and to the storage station and each conveyor means includes a plurality of parallel conveyors arranged close to each other side by side.

2. Device according to claim 1, wherein the number of conveyors in each conveyor means is three or four.

3. Device according to claim 1, wherein the conveyors in one and the same conveyor means are of different length.

4. Device according to claim 1, wherein driving means for the conveyors, which driving means is arranged to drive the conveyors of one conveyor means at different speeds.

5. Device according to claim 4, wherein the driving means includes one electric motor for each conveyor in a conveyor means.

6. Device according to claim 4, wherein the driving means includes one single motor for all conveyors in one conveyor means, whereby each conveyor is connected to the motor via an individual gear mechanism.

7. Device according to claim 1, wherein each conveyor includes at least one gripping device arranged for gripping a twist-lock.

8. Device according to claim 7, wherein the gripping device is an integral mechanical part of the conveyor to move simultaneously therewith.

9. Device according to claim 7, wherein positioning means is arranged to stop each conveyor at at least one predetermined position, corresponding to the position when the gripping device is right under a corner fitting.

10. Device according to claim 9, wherein the position means includes a sensor and/or a mechanical stop.

11. Device according to claim 1, wherein the conveyor means are arranged to transport twist-locks to and/or from the corner fittings of at least two containers connected to each other end against end.

12. Device according to claim 1 wherein said support structure is arranged to be able to receive at least one pair of container units with one unit in the pair of container units being situated above the other one, and being provided with a loading platform connected with the support structure and a transfer device connected with the support structure, which transfer device is arranged to move a container unit laterally, and comprises a laterally moveable grip frame arranged to be able to surround at least three of the vertical side walls of a container unit and which grip frame has inside dimensions that are greater than the cross-sectional dimensions of a container unit in a horizontal plane so that a vertical movement of a container unit through the grip frame is possible.

13. A method for coning a container unit including the step of inserting a twist-lock at each corner fitting in the bottom of the container unit comprising placing the container unit on a support structure with two parallel long sides and two end sides, providing a storage station adjacent and outside one of the end sides, providing conveyer means along each long side, which conveyer means each includes a plurality of parallel conveyors arranged closed to each other side by side, and transporting a twist-lock to each said corner fitting by said conveyor means from said storage station.

14. A method for deconing a container unit including the step of removing a twist-lock from each corner fitting in the bottom of the container unit comprising placing the container unit on a support structure with two parallel long sides and two end sides, providing a storage station adjacent and outside one of the end sides, providing conveyer means along each long side, which conveyor means each includes a plurality of parallel conveyors arranged close to each other side by side, and transporting a twist-lock from each said corner fitting by said conveyor means to said storage station.

15. A method according to claim 13, comprising performing the method by a device for coning and/or deconing a container unit having corner fittings for the attachment of twist-locks, which device has a support structure for the container unit, which support structure has two parallel long sides and two end sides, wherein the device further includes a storage station adjacent and outside a first of said end sides, a first conveyor means along a first of said long sides and a second conveyor means along a second of said long sides, each said conveyor means being arranged to transport twist-locks to and from the corner fittings from and to the storage station and each conveyor means includes a plurality of parallel conveyors arranged close to each other side by side.
